(19) United States
(12) Patent Application Publication
(10) Pub. No.: US 2018/0001711 A1
(43) Pub. Date: Jan. 4, 2018

(54) PNEUMATIC TIRE

(71) Applicant: Toyo Tire & Rubber Co., Ltd., Osaka (JP)

(72) Inventor: Tsuyoshi Fujioka, Osaka-shi (JP)

(73) Assignee: Toyo Tire & Rubber Co., Ltd., Osaka (JP)

(21) Appl. No.: 15/616,336

(22) Filed: Jun. 7, 2017

(30) Foreign Application Priority Data
Jun. 30, 2016 (JP) 2016-130532

(51) Int. Cl. B60C 11/12; B60C 11/03; B60C 11/13

(52) U.S. Cl. CPC B60C 11/1236; B60C 11/1353; B60C 11/1204; B60C 11/0309; B60C 2011/1213; B60C 2011/1361

(57) ABSTRACT

In a pneumatic tire, three or four zigzag main grooves extending in a tire circumferential direction with amplitude in a tire width direction, a plurality of lateral grooves extending in a direction intersecting the main grooves, and block rows formed by the main grooves and the lateral grooves are provided at a tread portion. When a tire is grounded, a ratio of a total sum of lengths of groove center lines of the main grooves in a ground contact surface to a total sum of lengths of amplitude center lines of the main grooves in the ground contact surface is set to 1.05 to 1.25.

### CROSS-REFERENCE TO RELATED APPLICATIONS

This application is based upon and claims the benefit of priority from the prior Japanese Patent Application No. 2016-130532, filed on Jun. 30, 2016; the entire contents of which are incorporated herein by reference.

### BACKGROUND

### 1. Field of the Invention

This embodiment relates to a pneumatic tire.

### 2. Related Art

There is a pneumatic tire in which block rows are formed at a tread portion by main grooves extending in a tire circumferential direction and lateral grooves intersecting the main grooves. In addition, it is also known as the main grooves, zigzag grooves extending in the tire circumferential direction and having amplitude in a tire width direction (see US2014/158261A1, US2012/000586A1, JP-A-2005-067246, and JP-A-2008-296795).

In the tire having the block pattern as described above, while it is required to improve a traction property, it is also required to suppress occurrence of uneven wear.

### SUMMARY

An object of this embodiment is to provide a pneumatic tire capable of satisfying both a traction property and uneven wear resistance property.

A pneumatic tire according to the embodiment includes a tread portion which is provided with three or four zigzag main grooves extending in a tire circumferential direction with amplitude in a tire width direction, a plurality of lateral grooves extending in a direction intersecting the main grooves, and block rows formed by the main grooves and the lateral grooves. The tread portion has a ground contact surface when a tire is grounded, and a ratio LA/LB of a total sum LA of lengths of groove center lines of the main grooves in the ground contact surface to a total sum LB of lengths of amplitude center lines of the main grooves in the ground contact surface is 1.05 to 1.25.

### BRIEF DESCRIPTION OF THE DRAWINGS

FIG. 1 is a perspective view of a pneumatic tire according to an embodiment.

FIG. 2 is partially enlarged perspective view of a tread portion of the same embodiment.

FIG. 3 is a developed view illustrating a tread pattern of the same embodiment.

FIG. 4 is a plan view of a center block of the same embodiment.

FIG. 5 is a plan view of a shoulder block of the same embodiment.

FIG. 6 is a view illustrating a ground contact surface shape of the pneumatic tire of the same embodiment.

FIG. 7 is a view illustrating a ground contact surface shape of a pneumatic tire of a comparative example.

### DETAILED DESCRIPTION

Hereinafter, embodiments will be described with reference to the drawings.

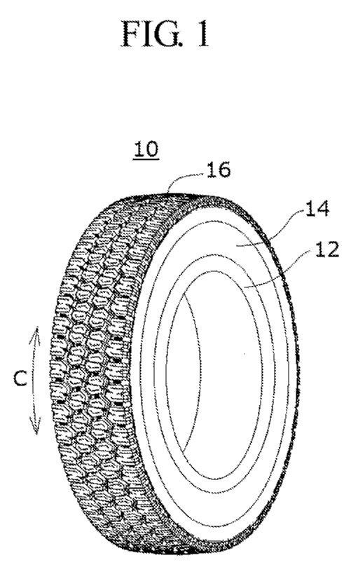

As illustrated in FIG. 1, a pneumatic tire 10 according to an embodiment includes a pair of right and left bead portions 12 and side wall portions 14, and a tread portion 16 that is provided between both side wall portions so as to connect radially outer end portions of the right and left side wall portions 14, and a general tire structure can be adopted for other than a tread pattern.

As illustrated in FIGS. 1 to 3, a plurality of block rows 22 formed by a plurality of main grooves 18 extending in a tire circumferential direction C and a plurality of lateral grooves 20 intersecting the main grooves 18 are provided on a tread rubber surface of the tread portion 16 in a tire width direction W.

In the example, three main grooves 18 are formed at intervals in the tire width direction W. A center main groove 18A positioned on a tire equator CL and a pair of shoulder main grooves 18B and 18B disposed on both sides is provided. Each of the three main grooves 18 is a zigzag groove extending in the tire circumferential direction C while being bent with amplitude in the tire width direction W. Moreover, the main groove 18 is a circumferential groove having a groove width (opening width) of generally 5 mm or more.

A plurality of land portions partitioned by the main grooves 18 are formed in the tread portion 16. The plurality of lateral grooves 20 are provided at intervals in the tire circumferential direction C. Therefore, each land portion is formed as the block row 22 in which a plurality of blocks are arranged in the tire circumferential direction C. More specifically, a pair of right and left center land portions sandwiched between the center main groove 18A and the shoulder main grooves 18B is formed as center block rows 22A formed by disposing a plurality of center blocks 24 in the tire circumferential direction C by providing lateral grooves 20A. The center block row 22A is a block row positioned at a central portion in the tire width direction W in the tread portion 16. In addition, a pair of right and left shoulder land portions sandwiched between the shoulder main groove 18B and a tire ground contact end E is formed as shoulder block rows 22B formed by disposing a plurality of shoulder blocks 26 in the tire circumferential direction C by providing the lateral grooves 20B. The shoulder block rows 22B are block rows positioned at both end portions in the tire width direction in the tread portion 16.

The lateral grooves 20A and 20B are grooves extending in a direction intersecting main grooves 18A and 18B, and crossing each land portion. The lateral grooves 20A and 20B may not necessarily be parallel to the tire width direction W as long as they are grooves extending in the tire width direction W. In the example, the lateral grooves 20A and 20B are grooves extending in the tire width direction W while being inclined.

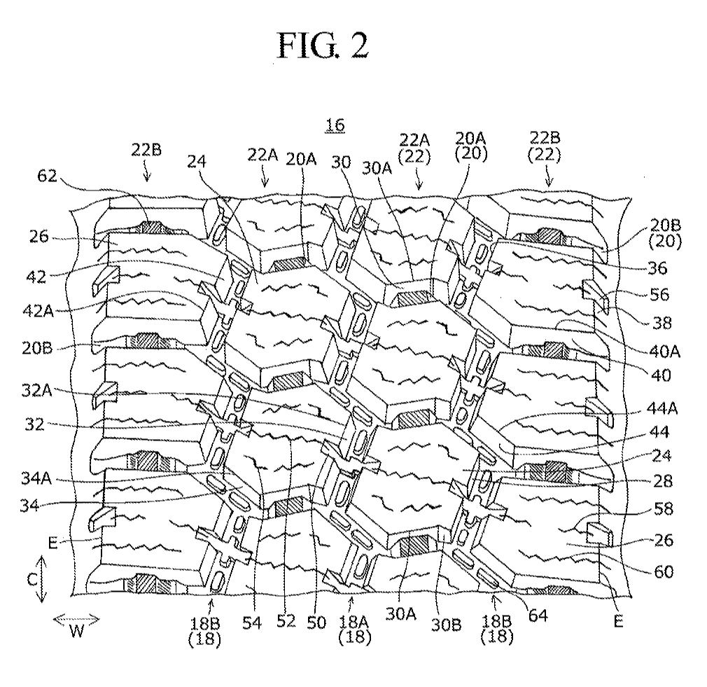

As illustrated in FIGS. 2 to 4, the center block 24 includes a pair of right and left longitudinal side surface portions 28 and 28 facing the right and left main grooves 18A and 18B, and a pair of front and rear lateral side surface portions 30 and 30 facing the front and rear lateral grooves 20A and 20A. Here, the longitudinal side surface portion 28 is a side surface portion facing the main groove 18 (that is, configuring a part of a groove wall surface of the main groove by being in contact with the main groove) out of side surface portions of the block 24. The lateral side surface portion 30 is a side surface portion facing the lateral groove 20 (that is, configuring a part of a groove wall surface of the lateral groove by being in contact with the lateral groove) out of the side surface portions of the block 24.

The pair of longitudinal side surface portions 28 and 28 is formed of a pair of first longitudinal side surface portions 32 and 32 having ridgelines 32A and 32A parallel to each other inclined with respect to the tire circumferential direction C, and a pair of second longitudinal side surface portions 34 and 34 having ridgelines 34A and 34A parallel to each other inclined greater with respect to the tire circumferential direction C than the ridgelines 32A of the first longitudinal side surface portions 32. Here, the ridgeline is a line generated at an intersection between a side surface and an upper surface (tread surface) of a block. The ridgeline 32A of the first longitudinal side surface portion 32 has a linear shape that is inclined to one side at an angle α with respect to the tire circumferential direction C. The ridgeline 34A of the second longitudinal side surface portion 34 has a linear shape that is inclined to another side at an angle β with respect to the tire circumferential direction C. Therefore, the angle β is set greater than the angle α (α<β). As an example, the angle α may be 10° to 30° and the angle β may be 30° to 55°. In addition, the ridgeline 34A of the second longitudinal side surface portion 34 is set shorter than the ridgeline 32A of the first longitudinal side surface portion 32 in length. That is, J1>J2, in which J1 is a length of the ridgeline 32A, and J2 is a length of the ridgeline 34A. Furthermore, the second longitudinal side surface portion 34 is formed so as to intersect the first longitudinal side surface portion 32 at an obtuse angle. That is, an angle θ between the ridgeline 32A of the first longitudinal side surface portion 32 and the ridgeline 34A of the second longitudinal side surface portion 34 is greater than 90° (θ>90°).

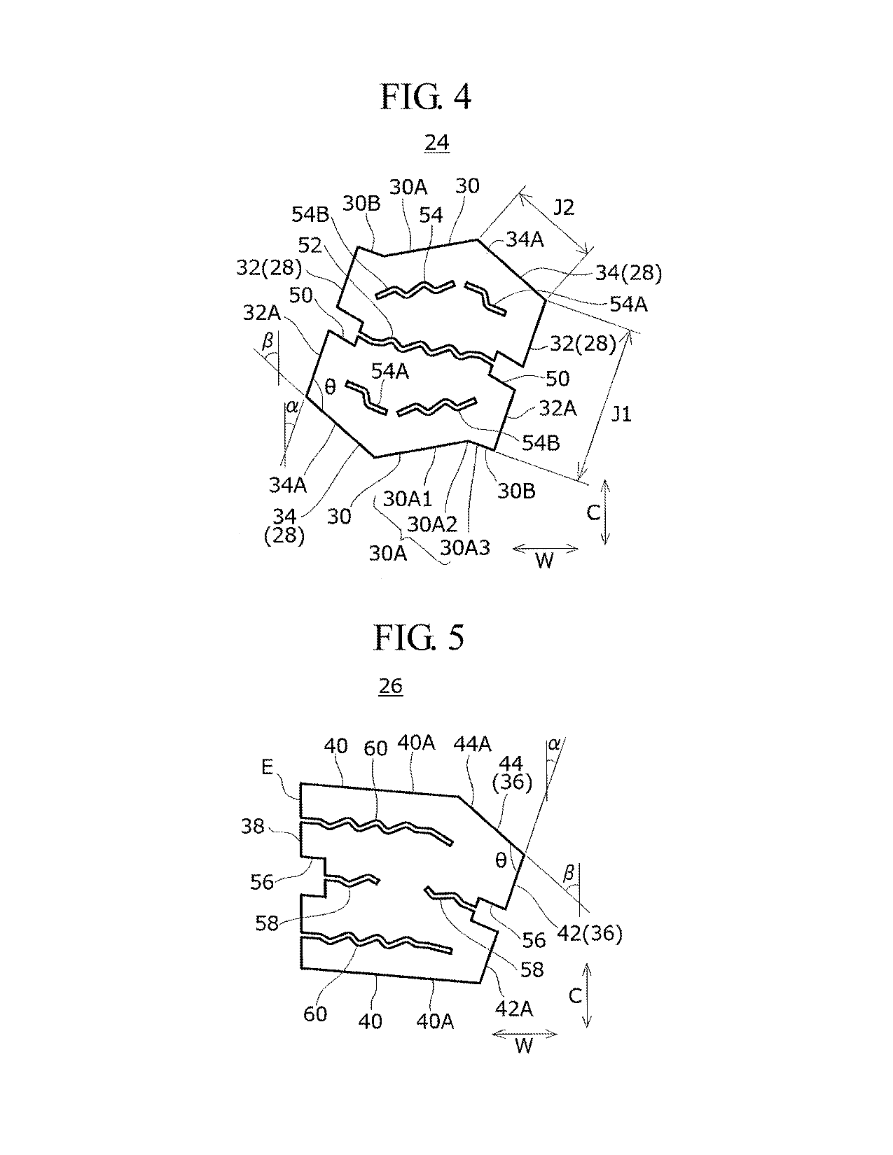

In addition, the pair of lateral side surface portions 30 and 30 is side surface portions having ridgelines 30A and 30A parallel to each other inclined with respect to the tire width direction W. An angle of the ridgeline 30A with respect to the tire width direction W may be, for example, 20° or less. The lateral side surface portion 30 is a side surface portion that is interposed between the first longitudinal side surface portion 32 of one longitudinal side surface portion 28 and the second longitudinal side surface portion 34 of the other longitudinal side surface portion 28, and connects them. As described above, as illustrated in FIG. 4, the center block 24 has a substantially hexagonal shape (convex hexagonal shape) in a plan view.

As illustrated in FIGS. 2, 3, and 5, the shoulder block 26 includes a longitudinal side surface portion 36 facing the shoulder main groove 18B, a longitudinal side surface portion 38 facing the tire ground contact end E, and a pair of front and rear lateral side surface portions 40 and 40 facing the front and rear lateral grooves 20B and 20B. Out of the side surface portions of the shoulder block 26, the longitudinal side surface portions 36 and 38 are side surface portions facing the main groove 18 or the ground contact end E (that is, configuring a part of the groove wall surface of the main groove or a ground contact end wall surface by being in contact with the main groove or the ground contact end). The lateral side surface portion 40 is a side surface portion facing the lateral groove 20B (that is, configuring a part of the groove wall surface of the lateral groove by being in contact with the lateral groove) out of the side surface portions of the shoulder block 26.

Similar to the longitudinal side surface portion 28, the longitudinal side surface portion 36 facing the shoulder main groove 18B is formed of a third longitudinal side surface portion 42 having a ridgeline 42A inclined with respect to the tire circumferential direction C, and a fourth longitudinal side surface portion 44 having a ridgeline 44A inclined greater with respect to the tire circumferential direction C than the ridgeline 42A of the third longitudinal side surface portion 42. The ridgeline 42A of the third longitudinal side surface portion 42 has a linear shape that is inclined to one side at the angle α with respect to the tire circumferential direction C. The ridgeline 44A of the fourth longitudinal side surface portion 44 has a linear shape that is inclined to another side at the angle β with respect to the tire circumferential direction C. The angle β is set greater than the angle α (α<β). In addition, the ridgeline 44A of the fourth longitudinal side surface portion 44 is set shorter than the ridgeline 42A of the third longitudinal side surface portion 42 in length. Furthermore, the fourth longitudinal side surface portion 44 is formed to intersect the third longitudinal side surface portion 42 at an obtuse angle (angle θ between the ridgeline 42A and the ridgeline 44A is greater than 90°).

In addition, the pair of lateral side surface portions 40 and 40 is a side surface portion having ridgelines 40A and 40A parallel to each other inclined with respect to the tire width direction W. An angle of the ridgeline 40A may be, for example, 20° or less with respect to the tire width direction W. As described above, as illustrated in FIG. 5, the shoulder block 26 has a substantially pentagonal shape (convex pentagonal shape) in a plan view.

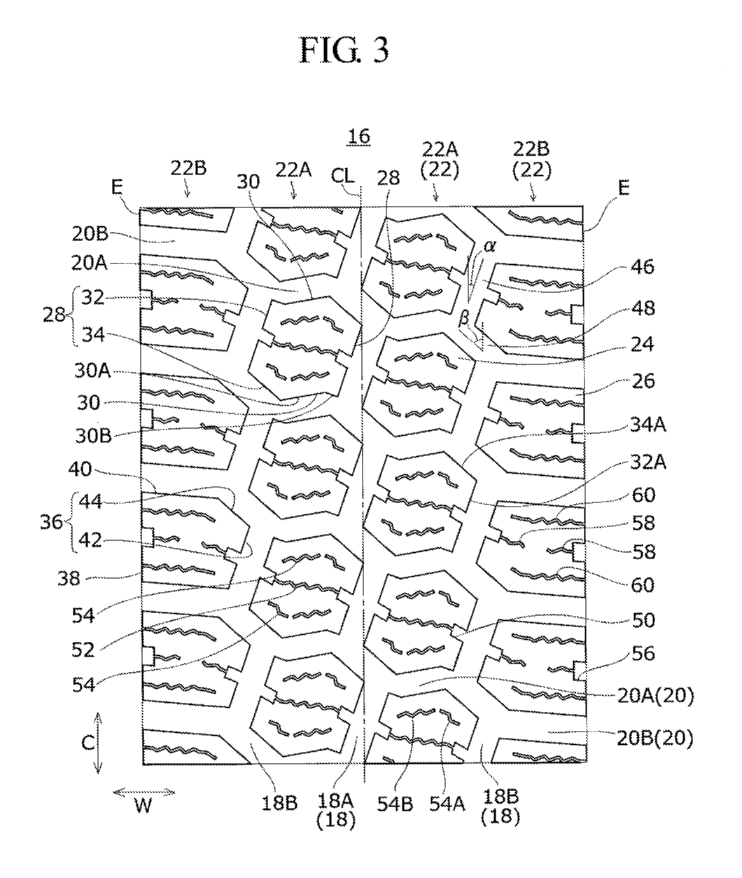

Because of the shapes of the center block 24 and the shoulder block 26 described above, the main groove 18 and the lateral groove 20 are provided as follows. As illustrated in FIG. 3, the main groove 18 has a first groove portion 46 that is inclined to one side at the angle α with respect to the tire circumferential direction C and a second groove portion 48 that is inclined to another side at an angle β with respect to the tire circumferential direction C, which are alternately repeated via an obtuse angle-shaped bent portion in the tire circumferential direction C thereby forming a zigzag shape. The second groove portion 48 is shorter than the first groove portion 46 in length and the inclined angle β with respect to the tire circumferential direction C is set greater than the inclined angle α of the first groove portion 46. Moreover, between adjacent main grooves 18A and 18B, top portions of the bent portions are disposed to face each other, the top portions are connected by the lateral groove 20A, and thereby the center block rows 22A are formed. In addition, the lateral grooves 20B are provided outward of the shoulder main groove 18B in the tire width direction from the top portion of each bent portion to the tire ground contact end E and thereby the shoulder block rows 22B are formed.

In the center block 24, notches 50 and 50 are respectively provided at the central portion of the pair of first longitudinal side surface portions 32 and 32 in the tire circumferential direction C. The notch 50 is a U-shaped recess in a plan view cut out toward a groove bottom of the main groove 18 from a block upper surface to a block bottom portion. The notch 50 is provided at the central portion of the first longitudinal side surface portion 32 in a ridgeline direction, that is, in the vicinity of the center of the ridgeline center.

The center block 24 is provided with a first sipe 52 which opens into the notches 50 and connects between the notches 50 and 50 on both sides. The first sipe 52 is a both-end open sipe which extends in the tire width direction W and of which the both ends open into the notches 50 thereby crossing the center block 24 in the tire width direction W.

The center block 24 is further provided with second sipes 54 respectively of which both ends terminate within the block 24 on both sides of the first sipe 52 in the tire circumferential direction. That is, in the center block 24, the second sipes 54, of which the both ends terminate within the block portions, are respectively provided in the block portions on the both sides in the tire circumferential direction partitioned by the first sipe 52. The second sipe 54 is a both-end closed sipe extending in the tire width direction W.

In the example, two second sipes 54 are provided on each of the both sides of the first sipe 52 in the tire circumferential direction. Specifically, the second sipe 54 is formed of one sipe 54A extending parallel to the ridgeline 34A of the second longitudinal side surface portion 34 and one sipe 54B extending parallel to the ridgeline 30A of the lateral side surface portion 30.

The lateral side surface portion 30 of the center block 24 is formed such that one end portion 30B in the tire width direction W protrudes within the lateral groove 20A. In the example, as illustrated in FIG. 4, the lateral side surface portion 30 is formed such that the end portion 30B at a joint portion to the first longitudinal side surface portion 32 protrudes in a bent shape. Specifically, the ridgeline 30A of the lateral side surface portion 30 is formed of a long side portion 30A1 extending obliquely with respect to the tire width direction W and a short side portion 30A3 inclined in a direction opposite to the long side portion 30A1 via a bent portion 30A2. Therefore, the lateral side surface portion 30 is provided with the end portion 30B of which the short side portion 30A3 is a ridgeline in a state of being protruded.

In the shoulder block 26, notches 56 and 56 are respectively provided at the central portions of the third longitudinal side surface portion 42 and the longitudinal side surface portion 38 facing the tire ground contact end E in the tire circumferential direction C. The notch 56 is a U-shaped recess in a plan view cut out from the block upper surface to a block bottom portion. The notches 56 are respectively provided at the central portions of the third longitudinal side surface portion 42 and the longitudinal side surface portion 38 in the ridgeline direction, that is, in the vicinity of the center of the ridgelines.

The shoulder block 26 is provided with a third sipe 58 of which one end opens into the notch 56 and the other end terminates within the shoulder block 26. The third sipe 58 is configured of two sipes extending in the tire width direction W, each one end opens into the notch 56 and the other ends terminate at positions at intervals each other in the tire width direction W. Therefore, a region in which a sipe is not present is secured at the central portion of the shoulder block 26.

The shoulder block 26 is further provided with fourth sipes 60 respectively on both sides of the third sipe 58 in the tire circumferential direction. In the example, in the fourth sipe 60, one end opens into the tire ground contact end E and the other end terminates within the shoulder block 26. The fourth sipes 60 are sipes extending in the tire width direction W and are respectively provided on the both sides of the third sipe 58 in the tire circumferential direction. The fourth sipe 60 extends from the tire ground contact end E toward an inside in the tire width direction W and terminates before reaching the shoulder main groove 18B beyond the center portion of the shoulder block 26 in the width direction.

In the example, although all the first, second, third, and fourth sipes 52, 54, 58, and 60 are the zigzag sipes which are bent at a plurality of places, the sipes may be linear sipes. In addition, the sipes 52, 54, 58, and 60 may not be necessarily parallel in the tire width direction W and may extend in the tire width direction W while being inclined as long as they extend in the tire width direction W. Groove widths of the sipes 52, 54, 58, and 60 are not particularly limited and, for example, may be 0.1 to 1.5 mm, may be 0.2 to 1.0 mm, or may be 0.3 to 0.8 mm.

A depth of the lateral groove 20 is not particularly limited and may be 30 to 80% of a depth of the main groove 18. Block rigidity can be easily secured and an effect of improving the uneven wear resistance property can be enhanced by making the depth of the lateral groove 20 shallow to 80% or less. In addition, a volume of the lateral groove is secured, an earth discharging property is improved, and an effect of improving the traction property can be enhanced by making the depth to 30% or more. As illustrated in FIG. 2, in the example, raised bridge portions 62, which connect respectively between the front and rear center blocks 24 and 24, and the front and rear shoulder blocks 26 and 26, are formed in the groove bottom of each of the lateral grooves 20A and 20B, and thereby the lateral groove 20 is formed shallower than the main groove 18.

As illustrated in FIG. 2, a plurality of protrusions 64 for preventing stone from biting are provided in the main grooves 18 at intervals in the tire circumferential direction C.

In the pneumatic tire 10 according to the embodiment, when the tire is grounded, a ratio LA/LB of a total sum LA of lengths of groove center lines P of the main grooves 18 in the ground contact surface to a total sum LB of lengths of amplitude center lines Q of the main grooves 18 in the ground contact surface is set 1.05 to 1.25. That is, 1.05≦LA/LB≦1.25.

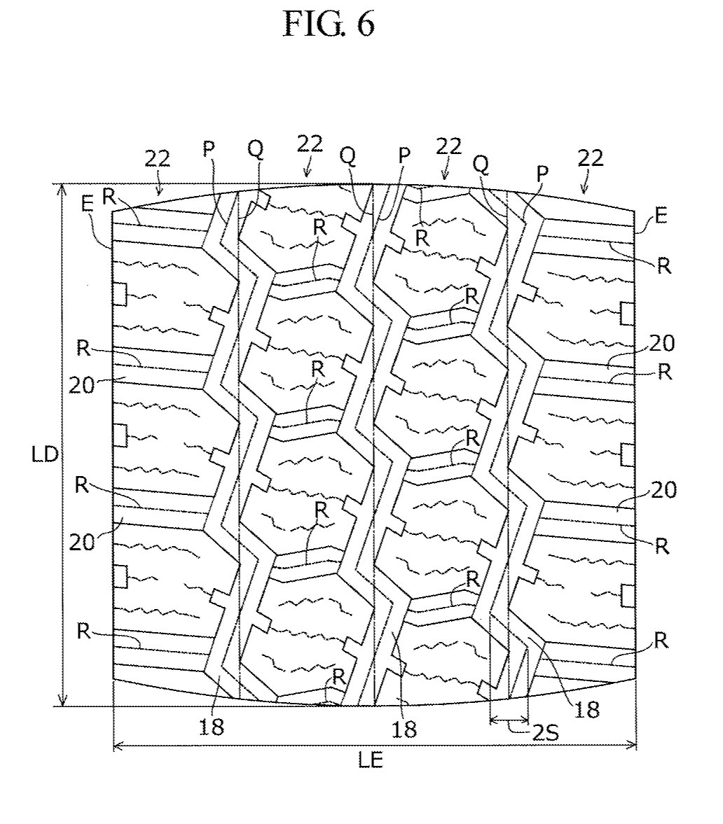

The shape of the ground contact surface is as illustrated in FIG. 6. In FIG. 6, in order to make it easier to understand the groove center lines of the main groove 18 and the lateral groove 20, a line is attached to a boundary between the main groove 18 and the lateral groove 20. Here, the groove center line P of the main groove 18 is a zigzag line passing through the groove width center (center in the width direction at each position in the length direction of the main groove) of the main groove 18. The total sum LA of the lengths of the groove center lines P is a total sum of the lengths of all the groove center lines P (three in FIG. 6) present in the ground contact surface. The amplitude center line Q of the main groove 18 is a straight line passing through a center of swing of the zigzag main groove 18 having an amplitude S in the tire width direction W. The total sum LB of the lengths of the amplitude center lines Q is a total sum of the lengths of all the amplitude center lines Q (three in FIG. 6) present in the ground contact surface.

According to the embodiment, the ratio LA/LB is set to 1.05 or more. Therefore, it is possible to improve the traction property by making the groove ridgeline longer than the pattern having the main groove extending linearly. In addition, the ratio LA/LB is set to 1.25 or less. Therefore, it is possible to prevent a swing width of the zigzag of the main groove from becoming excessively large, thereby suppressing a decrease in the uneven wear resistance property. Therefore, it is possible to satisfy both traction property and the uneven wear resistance property. The ratio LA/LB is more preferably 1.10 to 1.20.

Here, the ground contact surface is a tread surface where the pneumatic tire is rim-assembled to a regular rim, is placed perpendicular to a flat road surface in a state of being filled with a regular internal pressure, and is grounded to the road surface when a regular load is applied. The regular rim is a rim of which each standard is defined for each tire in a standard system including standards on which the tire is based, and is, for example, a “standard rim” in the JATMA, a “Design Rim” in the TRA, or a “Measuring Rim” in the ETRTO. The regular internal pressure is an air pressure of which each standard is defined for each tire in a standard system including standards on which the tire is based, and is, for example, the maximum air pressure in the JATMA, the maximum value described in the table “TIRE LOAD LIMITS AT VARIOUS COLD INFLATION PRESSURES” in the TRA, or “INFLATION PRESSURE” in the ETRTO, but it shall be 180 kPa if the tire is for a passenger car. In addition, the regular load is a load defined in each standard for each tire in the standard system including the standard on which the tire is based, the maximum load capacity in the JATMA, the maximum value described in the above table in the TRA, “LOAD CAPACITY” in the ETRTO, but the regular load is equivalent to 88% of the load if the tire is for a passenger car.

In the pneumatic tire 10 according to the embodiment, when the tire is grounded, the ratio LC/LA of the total sum LC of the lengths of the groove center lines R of the lateral grooves 20 in the ground contact surface to the total sum LA of the lengths of the groove center lines P of the main grooves 18 in the ground contact surface is set to 0.50 to 1.00. That is, 0.50≦LC/LA≦1.00. Here, the groove center line R of the lateral groove 20 is a line passing through the groove width center (center in the width direction at each position in the length direction of the lateral groove) of the lateral groove 20. The total sum LC of the lengths of the groove center lines R is a total sum of the lengths of all the groove center lines R present in the ground contact surface.

According to the present embodiment, the ratio LC/LA is set to 0.50 or more. Therefore, it is possible to secure the traction element (lateral groove element) in the ground contact surface and improve the traction property. Further, the ratio LC/LA is set to 1.00 or less. Therefore, it is possible to secure the area of the blocks 24 and 26 by preventing the lateral groove elements from becoming too large. Therefore, occurrence of uneven wear can be suppressed. The ratio LC/LA is more preferably 0.60 to 0.90, and still more preferably 0.70 to 0.80.

In the pneumatic tire 10 according to the embodiment, when the tire is grounded, the ratio LD/LE of the ground contact length LD to the ground contact width LE is set to 0.9 or more. That is, LD/LE≧0.9. Here, the ground contact length LD is the maximum length in the direction perpendicular to the tire width direction W on the ground contact surface, and is usually a length at the tire equator CL. The ground contact width LE is a distance between the ground contact ends E and E which are the outermost positions in the tire width direction W on the ground contact surface.

According to the embodiment, the ratio LD/LE is set to 0.9 or more. Therefore, it is possible to increase the number of lateral groove elements in the ground contact surface and to improve the traction property and the earth discharging property. The ratio LD/LE is preferably 1.0 or more. The upper limit of the ratio LD/LE is not particularly limited but is, for example, 1.3 or less.

Further, according to the embodiment, the main grooves 18 are zigzag grooves formed by alternately repeating in the tire circumferential direction C the first groove portions 46 which are inclined with respect to the tire circumferential direction C and the second groove portions 48 which are inclined greater with respect to the tire circumferential direction C than the first groove portions 46 and shorter than the first groove portions 46 in length via obtuse angle-shaped bent portions. Therefore, it is possible to improve the traction property while maintaining the uneven wear resistance property.

In the center block 24, the notches 50 are provided in the pair of first longitudinal side surface portions 32 and thereby it is possible to increase traction elements and to improve the traction property. In addition, the notches 50 are provided at the central portion of the first longitudinal side surface portion 32 and thereby it is possible to eliminate a difference in the rigidity in each block 24 and to suppress uneven wear. In addition, since the center block row 22A has a high ground contact pressure and a high traction effect, the first sipe 52 which opens into the notch 50 and connects between the notches 50 is provided in the center block 24, and thereby the effect of improving the traction property is excellent. In addition, the second sipes 54 are provided on both sides of the first sipe 52 in the tire circumferential direction and thereby it is possible to improve the traction property and to suppress uneven wear by equalizing the ground contact pressure within the center block 24. Furthermore, the second sipe 54 is a sipe of which the both ends terminate within the block. Therefore, it is possible to reduce the possibility of becoming a cause of block chipping.

According to the embodiment, the second sipes 54, which are provided on the both sides of the first sipe 52, are configured of the sipes 54A extending parallel to the ridgeline 34A of the second longitudinal side surface portion 34 and the sipes 54B extending parallel to the ridgeline 30A of the lateral side surface portion 30. Therefore, the ground contact pressure within the center block 24 is further uniformized and thereby it is possible to further suppress the uneven wear.

In addition, the lateral side surface portion 30 of the center block 24 is formed such that one end portion 30B in the tire width direction W protrudes within the lateral groove 20A. Therefore, when the tire is driven, the protruding end portion 30B moves and thereby earth (mud) entering into the lateral groove 20A can be discharged and it is possible to improve the earth discharging property.

According to the embodiment, in the shoulder block 26, the notches 56 are provided at the right and left longitudinal side surface portions 36 and 38, and thereby it is possible to increase the traction elements and to improve the traction property. In addition, the notches 56 are provided at the central portions of the third longitudinal side surface portion 42 and the longitudinal side surface portion 38, and thereby it is possible to eliminate the difference in rigidity in each block 26 and to suppress the uneven wear.

In addition, in general, uneven wear is likely to occur in the shoulder block 26 where forces are input from the longitudinal direction (the tire circumferential direction) and the lateral direction (the tire width direction). According to the embodiment, in the shoulder block 26, a pair of notches 56 and 56 is not connected by a sipe and the third sipe 58 which is disconnected at the central portion of the block is provided. Therefore, it is possible to secure the block rigidity and to suppress occurrence of the uneven wear. In addition, the fourth sipes 60 are respectively provided on the both sides of the third sipe 58, and thereby the ground contact pressure within the shoulder block 26 is uniformized and it is possible to suppress the uneven wear.

In addition, since a lateral force from the tire ground contact end E is input into the shoulder block 26, the fourth sipes 60 are formed so as to open into the tire ground contact end E. Therefore, it is possible to alleviate the lateral force and to improve the uneven wear resistance property.

In the embodiment described above, a case where the block row 22 includes the center block row 22A and the shoulder block row 22B is described, but the embodiment is not limited to such a tread pattern. It is possible to apply to various pneumatic tires which include a tread portion having three or four zigzag main grooves extending the tire circumferential direction with amplitude in the tire width direction, a plurality of lateral grooves extending in a direction intersecting the main grooves, and block rows formed by the main grooves and the lateral grooves. For example, the shoulder land portions may be provided such that the plurality of lateral grooves terminate within the shoulder land portions while being opened to the tire ground contact end, thereby being formed as shoulder ribs continuous in the tire circumferential direction.

The pneumatic tire according to the embodiment includes various vehicle tires such as a tire for a passenger car, a heavy duty tire of a truck, a bus, or a light truck (for example, an SUV vehicle or a pickup truck) or the like. In addition, applications such as a summer tire, a winter tire, and all-season tire are not particularly limited. It is preferable that the tire is the heavy duty tire.

Each dimension described above in the present specification is provided in a regular state with no load in which the pneumatic tire is mounted on a regular rim and is filled with air of a regular internal pressure unless mentioned in particular.

### EXAMPLES

In order to confirm the above effects, a heavy duty pneumatic tire (tire size: 11R22.5) of Examples 1 to 6, and Comparative Examples 1 to 4 was mounted on rims of 22.5×7.50, filled with air of an internal pressure of 700 kPa, mounted on a vehicle with a constant loading capacity of 10 t, and evaluated for the traction property, the earth discharging property, and the uneven wear resistance property.

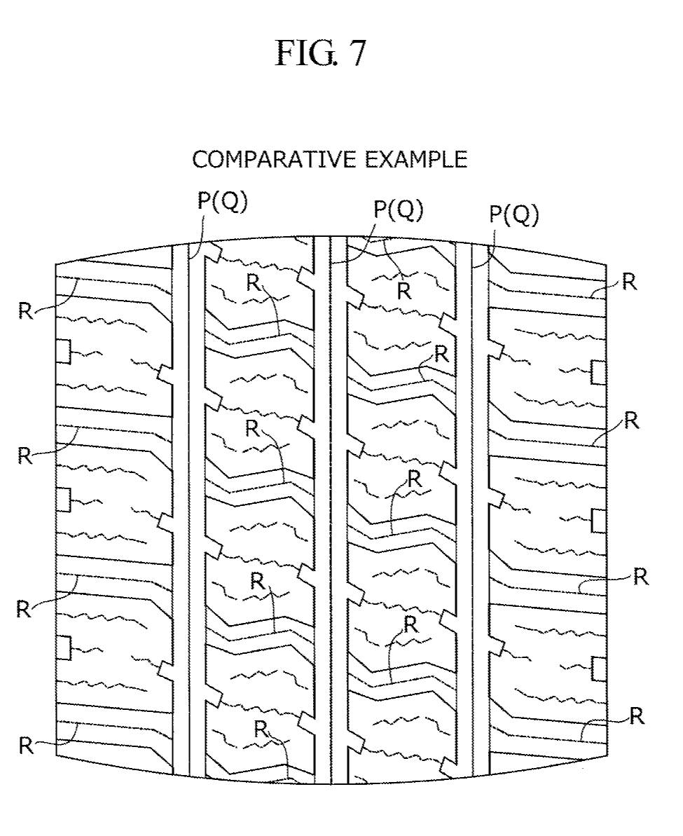

The tire of Example 4 includes features of the embodiment illustrated in FIGS. 1 to 6 (groove width of the main groove=11.5 mm, a depth of the main groove=16.5 mm, α=20°, β=47°, θ=113°, and J1/J2=1.7). In the tires of Examples 1 to 3, 5, and 6, and Comparative Example 3, the ratios LA/LB, LC/LA, and LD/LE were changed as in the following Table 1 on the basis of the tread pattern of Example 4. The tires of Comparative Examples 1, 2, and 4 are examples of tread patterns having straight main grooves illustrated in FIG. 7 (accordingly, the ratio LA/LB=1.00), and the ratios LC/LA and LD/LE are changed as in Table 1. The values of the ratios LA/LB and LC/LA can be adjusted, for example, by the amplitude and pitch of the zigzag main grooves, and the pitch of the lateral grooves. Here, the value of the ratio LA/LB was adjusted mainly by the amplitude of the main grooves and the value of the ratio LC/LA was adjusted mainly by the pitch of the lateral grooves to be respectively the values of Table 1. In addition, the value of the ratio LD/LE can be adjusted, for example, by the thickness of the tread rubber, the belt angle, and the number of belts. Here, the value thereof was adjusted by the thickness of the tread rubber and the belt angle to be the value of Table 1.

Each evaluation method is as follows.
The traction property: an arrival time when advanced 20 m from a stop state on a road surface having a water depth of 1.0 mm was measured, and an inverse number of the arrival time was indexed with the value of Comparative Example 1 taking as 100. The larger the index is, the shorter the arrival time is and the better the traction property is.
The earth discharging property (mud performance): an arrival time when advanced 20 m from a stop state on a muddy road was measured, and an inverse number of the arrival time was indexed with the value of Comparative Example 1 taking as 100. The larger the index is, the shorter the arrival time is and the better the earth discharging property is.
The uneven wear resistance property: an uneven wear state (heel and toe wear amount) after traveling 20,000 km was measured and an inverse number of the heel and toe wear amount was indexed with the value of Comparative Example 1 taking as 100. The larger the index is, the less uneven wear occurs and the more excellent the uneven wear resistance property is.

TABLE 1

| | Comparative | Comparative | Comparative | Comparative | Example | Example | Example | Example | Example | Example |
|---|---|---|---|---|---|---|---|---|---|---|
| | Example 1 | Example 2 | Example 3 | Example 4 | 1 | 2 | 3 | 4 | 5 | 6 |
| LA/LB | 1.00 | 1.00 | 1.40 | 1.00 | 1.05 | 1.05 | 1.25 | 1.15 | 1.15 | 1.15 |
| LC/LA | 0.40 | 0.75 | 1.20 | 0.40 | 0.50 | 0.50 | 1.00 | 0.75 | 0.50 | 0.40 |
| LD/LE | 0.9 | 0.7 | 0.7 | 0.7 | 0.9 | 1.1 | 1.1 | 1.1 | 1.1 | 0.7 |
| Traction property | 100 | 100 | 114 | 92 | 104 | 106 | 111 | 109 | 108 | 103 |
| Earth discharging | 100 | 97 | 97 | 97 | 100 | 104 | 104 | 104 | 104 | 97 |
| property | | | | | | | | | | |
| Uneven wear | 100 | 100 | 89 | 108 | 102 | 102 | 101 | 104 | 102 | 100 |
| resistance property | | | | | | | | | | |

As a result, as indicated by Table 1, in Examples 1 to 6 in which the ratio LA/LB is within the range of 1.05 to 1.25, the traction property was improved without impairing the uneven wear resistance property compared to Comparative Examples 1 and 2 in which the ratio LA/LB is 1.00. In Comparative Example 3, in which the ratio LA/LB was too large, although the traction property is excellent, the uneven wear resistance property remarkably is decreased. Further, in Comparative Example 4, since the ratio LC/LA is small and the ratio LD/LE is small, the number of lateral groove elements is small so that although the uneven wear resistance property is excellent, the traction property remarkably deteriorated.

As a result of comparing Examples 1 to 6, in Example 6, since the ratio LC/LA was small and the ratio LD/LE was small, the effect of improving the traction property was smaller than those in the other Examples. In Examples 3 to 5, since the ratio LA/LB was larger than those of Examples 1 and 2, the effect of improving the traction property was excellent. In Example 3, since both the ratios LA/LB and LC/LA were in the vicinity of the upper limit, the effect of improving the traction property was particularly high. Example 4 in which both the ratios LA/LB and LC/LA are in the vicinity of the intermediate value was the most excellent as the balance between the traction property, the uneven wear resistance property and the earth discharging property.

While several embodiments are described above, these embodiments are presented by way of example and are not intended to limit the scope of the invention. These novel embodiments can be implemented in various other forms, and various omissions, substitutions, and changes can be made without departing from the spirit of the invention.

What is claimed is:

1. A pneumatic tire comprising:
a tread portion which is provided with three or four zigzag main grooves extending in a tire circumferential direction with amplitude in a tire width direction, a plurality of lateral grooves extending in a direction intersecting the main grooves, and block rows formed by the main grooves and the lateral grooves,
wherein the tread portion has a ground contact surface when a tire is grounded, and a ratio LA/LB of a total sum LA of lengths of groove center lines of the main grooves in the ground contact surface to a total sum LB of lengths of amplitude center lines of the main grooves in the ground contact surface is 1.05 to 1.25.

2. The pneumatic tire according to claim 1,
wherein a ratio LC/LA of a total sum LC of lengths of groove center lines of the lateral grooves in the ground contact surface to the total sum LA of the lengths of the groove center lines of the main grooves in the ground contact surface is 0.50 to 1.00.

3. The pneumatic tire according to claim 1,
wherein a ratio LD/LE of a ground contact length LD in the ground contact surface to a ground contact width LE in the ground contact surface is 0.9 or more.

4. The pneumatic tire according to claim 1,
wherein the main grooves are zigzag grooves which comprises first groove portions which are inclined with respect to the tire circumferential direction and second groove portions which are shorter than the first groove portions in length and inclined greater with respect to the tire circumferential direction than the first groove portions, and is formed by alternately repeating the first groove portions and the second groove portions via obtuse angle-shaped bent portions in the tire circumferential direction.

5. The pneumatic tire according to claim 4,
wherein the block rows include a center block row which is positioned at a central portion of the tread portion in the tire width direction and is sandwiched between the main grooves,
wherein the center block row includes center blocks each including a pair of longitudinal side surface portions facing the main grooves and a pair of lateral side surface portions facing the lateral grooves, the pair of longitudinal side surface portions including a pair of first longitudinal side surface portions which has ridgelines inclined with respect to the tire circumferential direction and a pair of second longitudinal side surface portions which has ridgelines shorter than the ridgelines of the first longitudinal side surface portions in length and inclined greater with respect to the tire circumferential direction than the ridgelines of the first longitudinal side surface portions, and intersects the first longitudinal side surface portions at an obtuse angle, and
wherein each center block comprises notches formed at the central portions of the pair of first longitudinal side surface portions, a first sipe which is opened to the notches and connects the notches on both sides, and second sipes formed on both sides of the first sipe in the tire circumferential direction and having both ends thereof terminated within the block.

6. The pneumatic tire according to claim 4,
wherein the block rows include a shoulder block row which is positioned at end portion of the tread portion in the tire width direction and are sandwiched between the main groove and tire ground contact end,
wherein the shoulder block row includes shoulder blocks each including a longitudinal side surface portion facing the main groove, in which the longitudinal side surface portion includes a third longitudinal side surface portion that has ridgeline inclined with respect to the tire circumferential direction and a fourth longitudinal side surface portion that has ridgeline shorter than the ridgeline of the third longitudinal side surface portion in length and inclined greater with respect to the tire circumferential direction than the ridgeline of the third longitudinal side surface portion, and intersects the third longitudinal side surface portion at an obtuse angle, and
wherein each shoulder block comprises notches formed at a central portion of the third longitudinal side surface portion and at a central portion of a longitudinal side surface portion facing the tire ground contact end, a third sipe of which one end is opened to the notch and the other end terminates within the shoulder block, and fourth sipes formed on both sides of the third sipe in the tire circumferential direction and having one end opened to the tire ground contact end and the other end terminated within the shoulder block.
